(19) United States
(12) Patent Application Publication
(10) Pub. No.: US 2008/0143529 A1
(43) Pub. Date: Jun. 19, 2008

(54) Wireless Network System for the Detection of Intrusions

(76) Inventor: Jean-Louis Gauvreau, La Prairie (CA)

Correspondence Address: BROUILLETTE & PARTNERS, METCALFE TOWER, 1550 METCALFE STREET, SUITE 800, MONTREAL, QC, H3A-1X6, omitted

(21) Appl. No.: 11/948,237

(22) Filed: Nov. 30, 2007

Related U.S. Application Data
(63) Continuation-in-part of application No. 11/566,272, filed on Dec. 4, 2006.
Application No. 11/566,272 is a continuation-in-part of application No. 11/149,243, filed on Jun. 10, 2005, now abandoned.
(60) Provisional application No. 60/578,292, filed on Jun. 10, 2004.

(51) Int. Cl. G08B 13/18

(52) U.S. Cl. 340/567

(57) ABSTRACT

A wireless network system using the same radio-frequency (RF) signals both for communication and for intrusion detection is provided. The network system generally comprises a plurality of wireless nodes adapted to communicate with each other, directly or through other nodes, via radio-frequency signals. Each node is also generally capable of measuring the received signal strength (RSS) of the radio-frequency signals sent by its neighbouring nodes. By detecting a significant change or variation in the received signal strength, which is generally due to a change in the generally immediate physical environment of the receiving node, the node can determine if the variation in the received signal strength value is due to an intrusion in the RF channel or not and acts appropriately.

### CROSS-REFERENCE TO RELATED APPLICATIONS

The present patent application is a continuation-in-part of commonly assigned U.S. patent application Ser. No. 11/566,272, filed on Dec. 4, 2006, itself a continuation-in-part of commonly assigned U.S. patent application Ser. No. 11/149,243, filed on Jun. 10, 2005, itself a continuation-in-part of commonly assigned U.S. Provisional Patent Application No. 60/578,292, filed on Jun. 10, 2004. The disclosure of these patent applications is incorporated herein by reference.

### FIELD OF THE INVENTION

The present invention generally relates to systems and methods for the detection of intrusions. More specifically, the present invention relates to essentially wireless network systems used for intrusion detection.

### BACKGROUND OF THE INVENTION

Intrusion detection sensors can generally be categorized based on their application and on their underlying technology as shown in FIGS. 1 and 2.

More recently, extensive researches have been undertaken in order to combine intrusion detection sensors to nodes in wireless networks in order to define wireless sensor networks. As their name implies, wireless sensor networks generally comprises several wireless nodes which are adapted to communicate with each other according to one or more wireless communication protocols. Additionally, each of the wireless nodes of the network also generally comprises one or more intrusion detection sensors, connected thereto, which are used to sense the environment in order to detect potential intrusions. An example of such wireless sensor networks is described in the article “A Line in the Sand: A Wireless Sensor Network for Target Detection, Classification, and Tracking”.

However, wireless sensor nodes must combine two opposite requirements. On the one hand, in order to detect events, it is generally required that the sensors be active or awake most of the time. In other words, the nodes must generally be actively vigilant. On the other hand, keeping all the sensors of the nodes continuously active will drain the battery at an unacceptable rate and will overly limit the longevity of the node. A trade-off must therefore be found in order to reduce the energy consumption of the nodes in order to increase their longevity while at the same time, keeping the nodes vigilant enough to detect intrusions.

One solution proposed by the prior art was to create a hierarchy in the sensors comprised in each node. In this system, a single primary sensor, i.e. a passive infra-red sensor, is kept active most of the time in order for the node to be at least passively vigilant and be able to detect intrusions. However, if the primary sensor detects an intrusion, it activates one or more of the other secondary sensors, which generally have a higher energy consumption, in order to confirm or infirm the reality of the intrusion.

In another prior art solution, a radar is used as primary sensor when the other sensors are inactive.

Still, in the foregoing solutions, a sensor is generally always kept awake and therefore continuously consumes energy, thereby reducing the longevity of the wireless node. Moreover, these sensors are an additional hardware cost and generally require a direct line-of-sight to detect intrusions or are adversely affected by the shadowing phenomenon.

Accordingly, there is a need for an improved intrusion detection system which mitigates the shortcomings of the prior art.

### OBJECTS OF THE INVENTION

Accordingly, an object of the present invention is to provide a wireless network system in which the radio-frequency transmissions occurring between the wireless nodes are used both for communication and intrusion detection.

Another object of the present invention is to provide a wireless network system in which the same hardware components of the wireless nodes (e.g. antenna, receiver and transmitter) are essentially used both for communication and intrusion detection.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

Accordingly, the present invention generally provides a wireless network system wherein the radio-frequency transmissions occurring between adjacent wireless nodes are used both for communication and for intrusion detection.

The wireless network system of the present invention therefore generally comprises a plurality of wireless nodes, each wireless node of the network generally comprising a transceiver for transmitting and receiving radio-frequency signals to and from neighbouring wireless nodes and therefore for communicating therewith.

According to an important aspect of the present invention, each wireless node further comprises a module, such as a power detector, for measuring the received signal strength of the radio-frequency signals it receives from its neighbouring nodes. Understandably, the power detector could be unitary and fully integrated with the transceiver whereby the demodulation and the power measurement of the signals would be done generally simultaneously; the present invention is not so limited.

In use, as the wireless network system is deployed, the nodes will generally automatically create a network, such as an ad-hoc mesh network, in order to be able to transmit information between themselves and also toward one of the nodes which is preferably also connected to a wide area network such as, but not limited to, the Internet, a cellular network or a satellite network. Understandably, other network topologies are also possible.

Therefore, at any given time, each node will generally be either receiving or sending radio-frequency signals from or to neighbouring nodes. The type of information transmitted between nodes can vary. For example, nodes can transmit routing information, node status information, etc.

Still, one of the important aspects of the present invention is that as each wireless node receives radio-frequency signals, it will also generally measure the received signal strength of the signals in order to detect possible significant variations.

As used hereinabove and hereinafter, the generally equivalent expressions “significant change”, “significant variation”, “predetermined change” and “predetermined variation” must be construed as any variation or change in the received signal strength of the radio-frequency signals which should be considered as abnormal according to the conditions in which the network has been deployed and/or according to the required level of vigilance of the network. Accordingly, a “significant change” in a noisy environment will generally be different from a “significant change” in a clear environment. Also, in an environment where the required level of vigilance of the network is high, the significance of the change might be lower than in an environment where the required level of vigilance is lower. The level of change may also be adaptative.

Moreover, it is to be understood that numerous causes can create a variation in the received signal strength of a radio-frequency signal and that accordingly, a “significant change” may have to be discriminated from a “non-significant change”. Generally speaking, causes for “non-significant changes” encompass, in a non-exhaustive list, background electro-magnetic noise (e.g. industrial equipment), weather (e.g. wind or rain causing motion in foliage), periodic motion of equipment (e.g. escalator, oil well pump), third party communications (particularly but not exclusively in unregulated radio-frequency bands), communications from other nodes in the same network which are not part of the transceiver-receiver pair but share the same airspace.

It is thus left to the skilled addressee to determine, for each particular setting, what is an appropriate “significant change”. In any case, the wireless nodes can be provided with appropriate software or softwares using techniques such as, but not limited to, template comparison, expert system, heuristic and signal analysis, in order to discriminate “significant changes” from “non-significant changes”. The present invention is not so limited.

Hence, if, during a communication between two nodes, a significant change or variation of the received signal strength occurs, then, the probabilities are high that someone or something has entered in the radio-frequency channel existing between the two communicating nodes. In that case, an intrusion is likely occurring and specific actions are most preferably needed. Therefore, upon the occurrence of such a significant change in the measured received signal strength, the receiving node may notify the other nodes in the network that an intrusion is likely occurring or may turn on additional sensors to further validate or classify the event. Additionally, the node or nodes which are further connected to a wide area network (WAN) via, for example, a modem, can further transmit the intrusion notification message to a central server for further processing.

In an alternate embodiment of the present invention, a single wireless node can be used for the detection of intrusions. In this alternate embodiment, the wireless node preferably continuously transmits radio-frequency signals with a transmitting antenna generally orthogonally polarized with respect to the receiving antenna. A portion of the radio-frequency signals sent by the node will be received by the same node due to the multiple reflections of the signals in the surrounding environment. The node, which is adapted to measure the strength of the received signals, will verify that there are no significant changes in the received signal strength. If a significant change is detected, the node concludes that a physical change (e.g. an intrusion) is likely occurring in the radio-frequency channel defined around the node. In response to this possible physical change, the node can take appropriate actions.

In this alternate embodiment, the information about the intrusion is preferably stored in the node until it is retrieved later by external means. The event information could also be transmitted to a wide area network, via a modem, if the node is appropriately equipped to do so.

Still, since the nodes of the present invention are able to monitor an area even without the presence, temporary or not, of other nodes, a node that temporary loses connection with the network will still be able to continue it monitoring activities until it re-establishes a connection with the network.

Therefore, the present invention generally relies on the detection of a significant variation of the received signal strength of the radio-frequency signals received by a node in order to detect intrusions. Still, since the nodes will generally be communicating with or without the occurrence of an intrusion, the nodes will not consume additional energy for the detection of intrusions. In fact, minimal vigilance will generally be insured by the generally continuous monitoring of the received signal strength of the received radio-frequency signals which are used for communication between nodes.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 presents the technological categories of interior intrusion detection sensors.

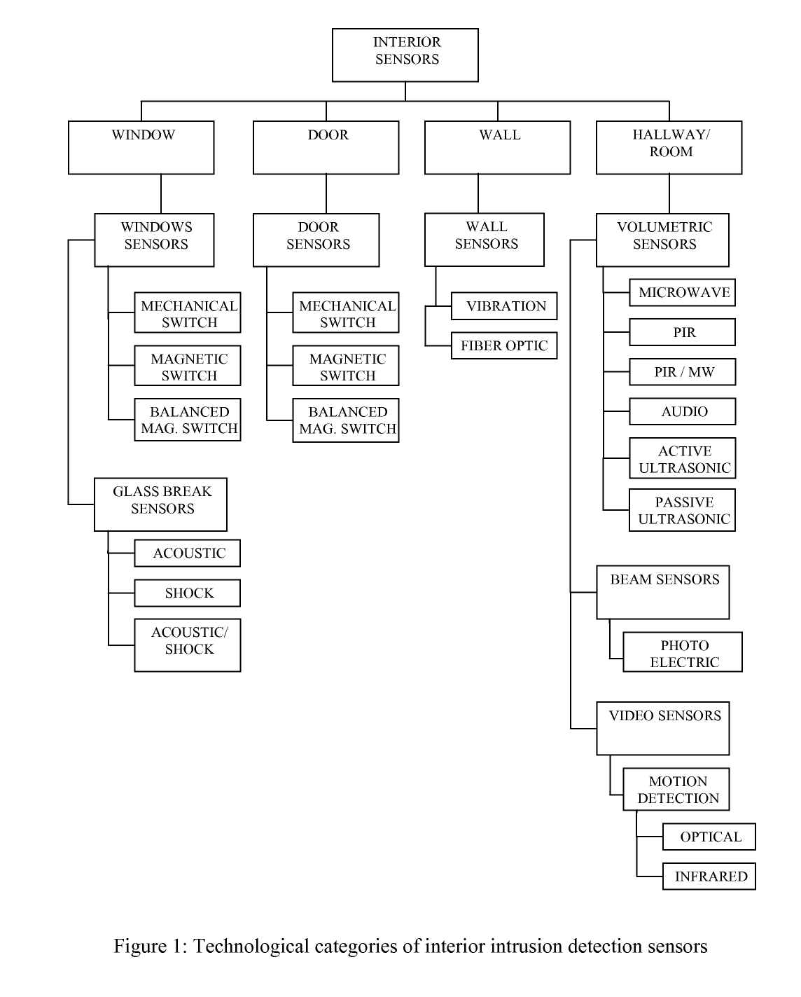

FIG. 2 presents the technological categories of exterior intrusion detection sensors.

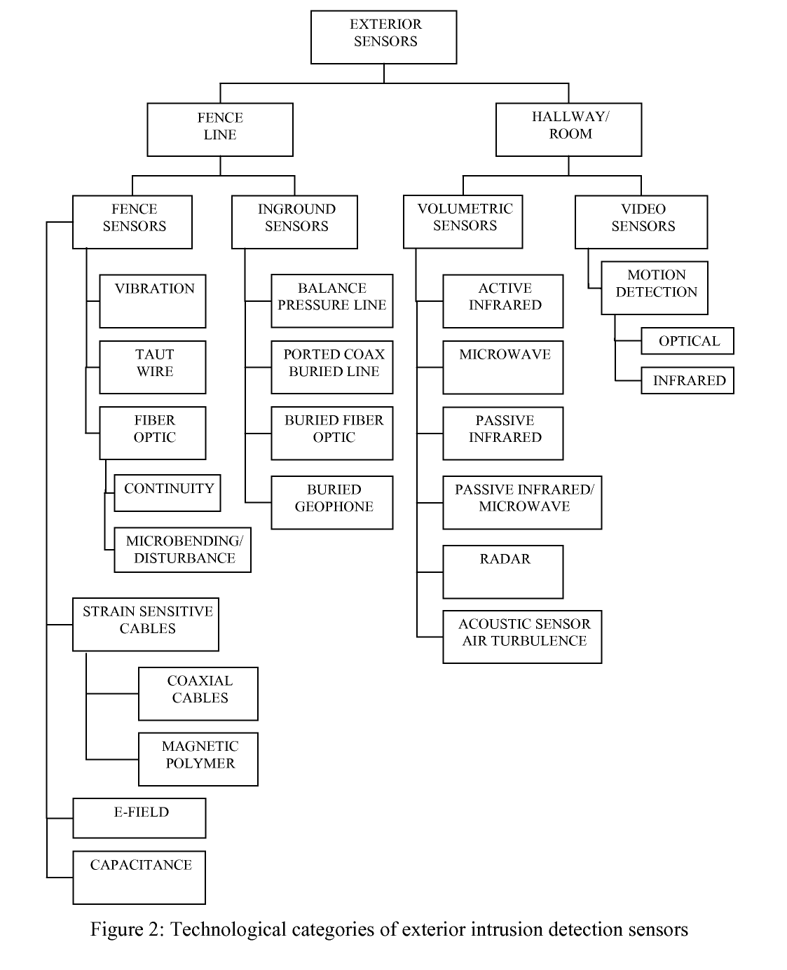

FIG. 3 is a schematic view of a wireless network according to one embodiment of the present invention.

FIG. 4 is a schematic view of a wireless node according to another embodiment of the present invention.

FIG. 5 is a schematic view of elements of the wireless node of FIGS. 3 and 4.

FIG. 6 presents sample plots of the received signal strength over time according to a deployment of the network of FIG. 3 in an office setting;

FIG. 7 presents sample plots of the received signal strength over time according to a deployment of the network of FIG. 3 in a freight container setting with both wireless nodes inside the container;

FIG. 8 presents sample plots of the received signal strength over time according to a deployment of the network of FIG. 3 in an freight container setting with one wireless node inside the container and one outside;

### DETAILED DESCRIPTION OF THE PREFERRED EMBODIMENT

A novel wireless network system which is adapted to detect intrusions will be described hereinafter. Although the invention is described in terms of specific illustrative embodiments, it is to be understood that the embodiments described herein are by way of example only and that the scope of the invention is not intended to be limited thereby.

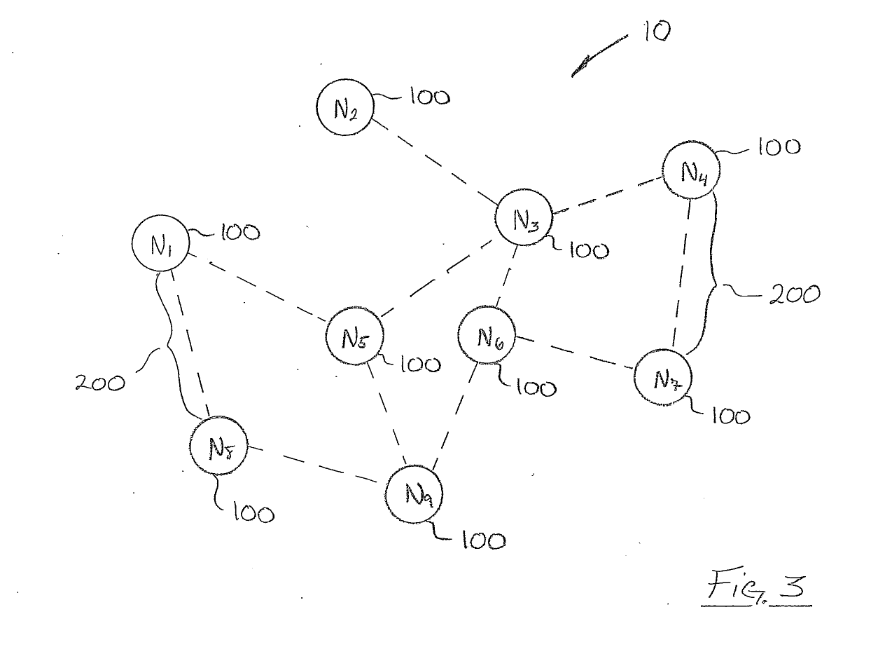

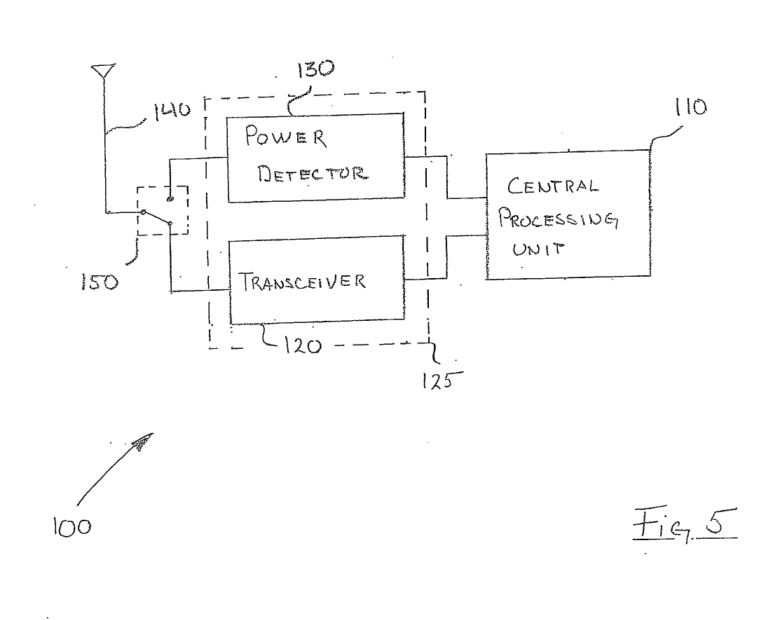

Referring first to FIG. 3, a first embodiment of the present invention is shown. The wireless network 10 of the present invention generally comprises a plurality of wireless nodes 100 which are adapted to communicate with each other via radio-frequency signals. Accordingly, a radio-frequency channel 200, schematically shown in FIG. 3 in dashed lines, is defined between each pair of nodes 100 which are within range of each other. Understandably, the actual radio-frequency channel 200 will depend on the location of the nodes 100, the radiating pattern of the antennas 140 (see FIG. 5) and the environment in which the network 10 is deployed.

Referring now to FIG. 5, each node 100 of the network 10 is substantially similar to the others and comprises a central processing unit 110 which processes all the information sent and/or received by the nodes 100. The node 100 also generally includes data storage modules, such as volatile and/or non-volatile memories (not shown for clarity). The node 100 also comprises a transceiver 120 which is adapted to send and receive radio-frequency signals to and from other neighbouring nodes 100. Understandably, the transceiver 120 is further connected to an antenna 140 via switching means such as a switch 150 or any other similar physical or electronic switching component. Also connected to the antenna 140, via the switch 150, is a power detector 130 which is adapted to measure the power level or strength of the received radio-frequency signals. The power detector 130 is also connected to the central processing unit 110.

Alternatively, the transceiver 120 and the power detector 130 could be unitary and fully integrated into a single component 125 whereby the single component 125 would be able to simultaneously modulate/demodulate and measure the power level of radio-frequency signals. Understandably, in this alternative embodiment, the switching means 150 would not be necessary.

In any case, it is important to note that the transceiver 120 and the antenna 140 are used both for communications between nodes 100 and for intrusion detection.

As the nodes 100 of the network 10 communicate with each other, radio-frequency signals are sent and received by different nodes 100. According to the present invention, as the radio-frequency signals are received by a node 100, a portion thereof is sent to the transceiver 120 for demodulation and decoding and another portion thereof is sent to the power detector 130 in order to measure the received signal strength of the received signals.

Understandably, should the transceiver 120 and the power detector be unitary and fully integrated into a single component 125, the demodulation and the power measurement of the received radio-frequency signals would be done generally simultaneously by the component 125.

If, during the reception of radio-frequency signals, the node 100, via the power detector 130 and the central processing unit 110, detects a significant change or variation therein, the central processing unit 110 will conclude that someone or something is affecting the radio-frequency channel 200 and therefore that an intrusion is likely to be occurring. Thereafter, the central processing unit 110 will preferably transmit an intrusion detection message to its neighbouring nodes 100. The neighbouring nodes 100 can then further confirm the intrusion. Also, should one of the wireless nodes 100 in the network 10 further comprises a modem unit (not shown) allowing it to be connected to a central server via a wide area network (e.g. the Internet, a cellular network, a satellite network, etc.), the intrusion detection message would preferably be relayed to that node 100, directly or via other nodes 100, in order for the intrusion detection message to be transmitted to the central server for further processing.

According to the preferred embodiment, the detection of a significant change in the received signal strength can be effected using the following algorithm.

The node 100 stores the latest received signal strength measurement and also, if applicable, the frequency on which the signal was transmitted. Then, the node 100 compares the latest received signal strength measurement with the previously received signal strength measurement for the same frequency. The absolute difference between both measurements is then stored in a buffer of size N which comprises the N latest computed differences. The buffer is preferably common for all frequencies if multiple frequencies are used in the network 10. A moving average of the N latest differences is then computed whereby if the difference between the latest received signal strength measurement and the previously received signal strength measurement, for the same frequency, goes beyond a threshold value with respect to the moving average, the node 100 concludes that an intrusion is occurring or has recently occurred. Understandably, the threshold value is directly related to the significance of a variation.

Understandably, the exact value of the threshold value is chosen by the skilled person deploying the network 10 and is generally though not exclusively based on several parameters such as the level of background noise, the presence of third party communications and the desired level of sensibility and vigilance. Alternatively, the threshold value could be determined by the wireless nodes 100 themselves or could be downloaded from a central server if the latter is available. Other ways to determine the threshold value are also possible. In any case, the skilled addressee shall understand that the threshold value can be static or dynamic; the invention is not so limited.

Furthermore, the algorithm could also be adapted to filter out erroneous measurements such as measurements which are abnormally below the average received signal strength measurements or measurements coming from frequencies having an abnormal volatility in their received signal strength measurements.

It is to be understood that since the present invention is embodied in a wireless network, the intelligence of the network can be distributed among the nodes 100. For example, if a node 100 detects a possible intrusion coming from a particular direction, the node 100 can relay this information to neighbouring nodes 100 in that particular area in order to increase the vigilance of the network 10 in that particular area. Additionally, as the skilled addressee would understand, if several nodes 100 simultaneously or sequentially detect the same intrusion, the central sensor fusion node or dedicated server, if available, could process the numerous intrusion detection messages it receives in order to extract more information about the intruder (e.g. location information, tracking information, etc.).

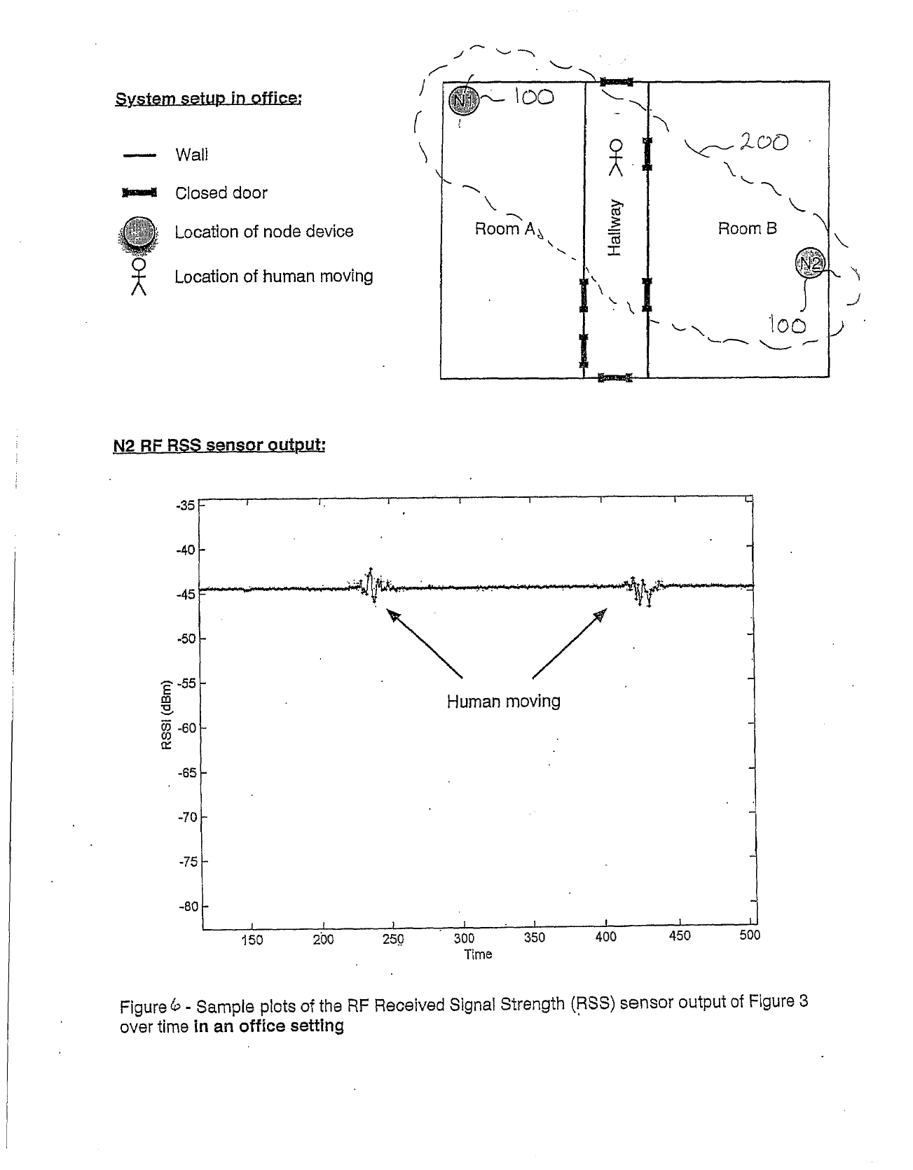

Non-limitative examples of deployments of the network 10 of the present invention are shown in FIGS. 6 to 8. In FIG. 6, the network comprises at least two nodes 100 which are deployed in two rooms separated by a hallway. As shown in the received signal strength output graph, if, for example, a person travels down the hallway, its entry into the radio-frequency channel 200 defined between the two nodes 100 will generate a variation in the received signal strength and the receiving node 100 will determine that in intrusion is occurring.

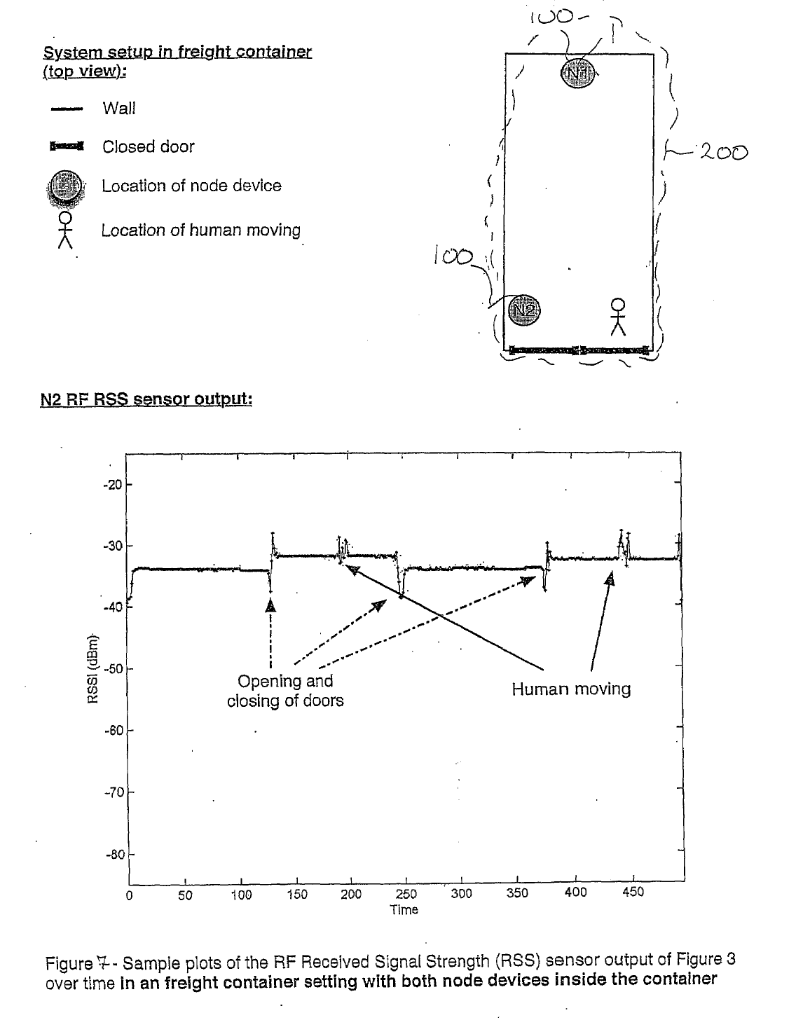

In FIG. 7, the network 10 is deployed inside a container. In that setting, any movement occurring in the container will affect the radio-frequency channel 200 and therefore will cause a variation in the received signal strength. Upon the occurrence of the variation, the receiving node 100 will conclude that an intrusion is occurring inside the container.

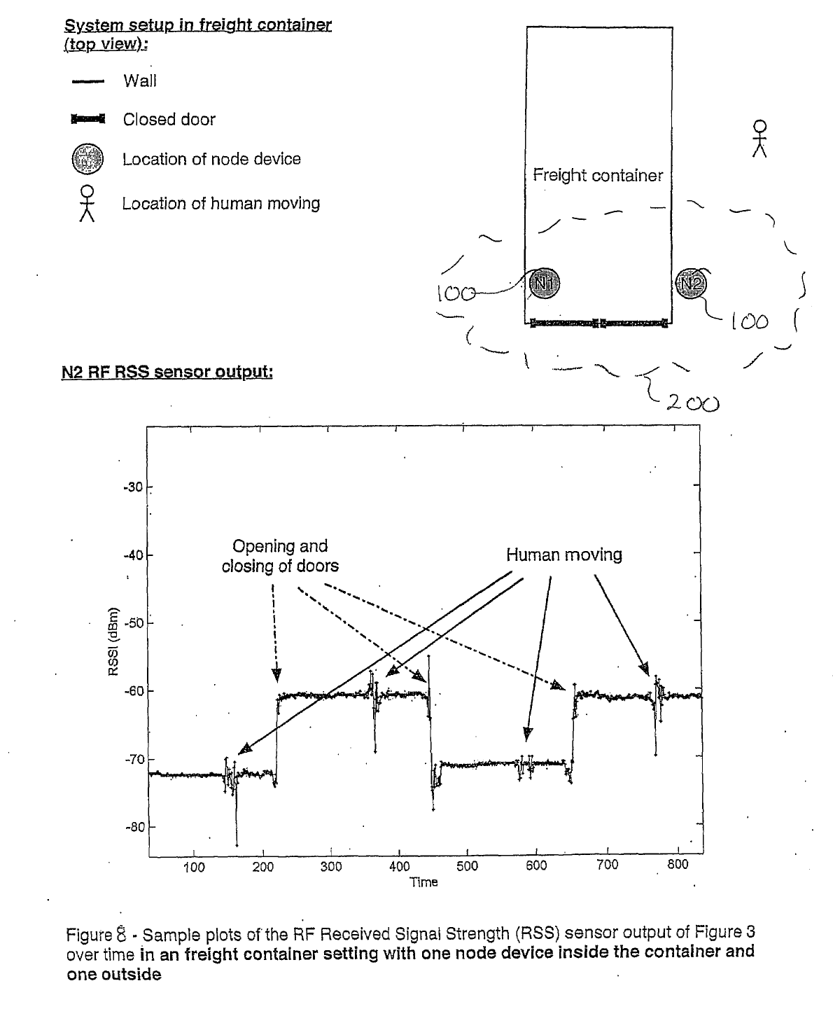

In FIG. 8, which is similar to FIG. 7, the nodes 100 of the network 10 are installed inside and outside the container. In that alternate setting, any events such as the opening or closing of the container's doors or the approaching of a person or vehicle will affect the radio-frequency channel 200 and therefore will cause a variation in the received signal strength. Upon the detection of such a significant variation, the receiving node 100 can determine that an intrusion is occurring.

Understandably, the number of nodes 100 in the network 10 can vary depending upon the desired area of coverage and/or on the particular setting in which the network will be deployed. Hence, in an open space such as on a battlefield, the network 10 could comprise tens and even hundreds of nodes 100 whereas in an office setting, the number of nodes could be more limited.

Yet, since the nodes 100 are adapted to communicate with each others and to define a preferably ad-hoc mesh network 10, the coverage of an area can easily be increased by increasing the number of nodes 100 in the network 10.

For example, in FIG. 6, it would be possible to add one or more nodes 100 in order to increase the coverage of the area and/or to cover more rooms. Also, in FIGS. 7 and 8, should two or more containers equipped with nodes 100 be placed near one another, the nodes 100 of one container could communicate with the nodes 100 of an adjacent container, thereby increasing the coverage area to a cluster of containers.

By using the received signal strength of the communication transmissions as a mean to determine if an intrusion is occurring and therefore to determine if further actions are required, the nodes 100 of the network 10 of the present invention generally do not use additional hardware and thus, additional power, as in the prior art, to keep the nodes 100 vigilant enough to detect possible intrusions.

Indeed, each node 100 monitor the received power of the received radio-frequency signals which are transmitted with or without the occurrence of an intrusion since the nodes 100 of the network 10 will generally always be communicating.

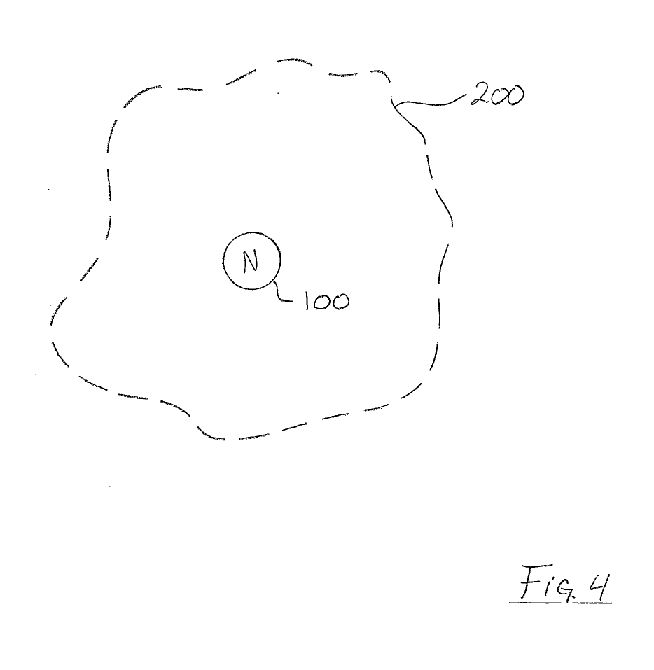

In a variant of the present invention shown in FIG. 4, a node 100 is used as a stand alone node. In that embodiment, the node 100 emits radio-frequency signals which are partially reflected back by structural elements located in the surroundings of the node 100.

As for the first embodiment, the node 100 in this second embodiment will preferably continuously monitor the power level or strength of the received radio-frequency signals. If a significant change appears in the received signal strength, the central processing unit 110 will conclude that an intrusion is occurring or has recently occurred in the surroundings of the node 100 since the reflection pattern of the signals has significantly changed.

In response, unless the node 100 has access to a wide area network via a modem, the node will store the event information in its memory for later retrieval.

Still, as mentioned above, the first and second embodiments of present invention are complementary since a node 100 in a deployed network 10 could temporary lose connection with its neighbouring nodes 100 and become a single node 100. Nevertheless, this singled-out node 100 could still monitor its surroundings and store intrusion information on its storage modules until the connection with its neighbouring nodes 100 is re-established.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A wireless network system for the detection of intrusions, said network system comprising a plurality of nodes, each node comprising:
a. processing means;
b. transceiving means in electronic communication with said processing means and adapted to transmit and receive data carrying radio-frequency signals;
c. power measuring means in electronic communication with said processing means and adapted to measure the received signal strength of said radio-frequency signals;
d. an antenna in electronic communication with said transceiving means and said power measuring means;
wherein each of said nodes is adapted to transmit and received said data carrying radio-frequency signals and wherein when one of said nodes detects at least a significant variation in said received signal strength, said processing means of said node determines that a intrusion is occurring.

2. A wireless network system as claimed in claim 1, wherein at least one of said nodes further comprises a modem in communication with a wide area network.

3. A wireless network system as claimed in claim 1, wherein said system further comprises a central sever connected to said wide area network.

4. A wireless network system as claimed in claim 1, wherein each of said nodes further comprises memory storage means, said memory storage means being in electronic communication with said processing means.

5. A wireless network system as claimed in claim 4, wherein each of said nodes further comprises a threshold value stored on said memory storage means.

6. A wireless network system as claimed in claim 5, wherein the significance of said significant variation in said received signal strength is determined by comparing said significant variation to said threshold value stored on said memory storage means.

7. A wireless network system as claimed in claim 6, wherein said threshold value is a static value.

8. A wireless network system as claimed in claim 6, wherein said threshold value is a dynamic value which is computed by said processing means.

9. A wireless node comprising:
a. processing means;
b. transceiving means in electronic communication with said processing means and adapted to transmit and receive radio-frequency signals;
c. power measuring means in electronic communication with said processing means and adapted to measure the received signal strength of said radio-frequency signals;
d. an antenna in electronic communication with said transceiving means and said power measuring means;
wherein said node is adapted to transmit and received said radio-frequency signals and wherein when said node detects at least a significant variation in said received signal strength, said processing means of said node determines that a intrusion is occurring.

10. A wireless node as claimed in claim 9, wherein said node further comprises memory storage means, said memory storage means being in electronic communication with said processing means.

11. A wireless network system as claimed in claim 10, wherein said node further comprises a threshold value stored on said memory storage means.

12. A wireless network system as claimed in claim 11, wherein the significance of said significant variation in said received signal strength is determined by comparing said significant variation to said threshold value stored on said memory storage means.

13. A wireless network system as claimed in claim 12, wherein said threshold value is a static value.

14. A wireless network system as claimed in claim 12, wherein said threshold value is a dynamic value which is computed by said processing means.

15. A method for detecting intrusions using a wireless network system comprising a plurality of nodes adapted to transmit and receive radio-frequency signals, said method comprising the steps of:
a. one of said nodes transmitting said radio-frequency signals in a radio-frequency channel to at least another one of said nodes;
b. said another one of said nodes receiving said transmitted radio-frequency signals;
c. said another one of said nodes measuring the received signal strength of said received radio-frequency signals;
d. said another one of said nodes comparing said measured received signal strength of said received radio-frequency signals with at least one threshold value;
e. said another one of said nodes determining if a variation in said measured received signal strength is determinative of an intrusion;
wherein said transmitted radio-frequency signals carry data to be transmitted from said one of said nodes to said another one of said nodes.

16. A method for detecting intrusions as claimed in claim 15, wherein said another one of said nodes further transmits an intrusion detection message to said nodes which are adjacent thereto.

17. A method for detecting intrusions as claimed in claim 15, wherein said another one of said nodes further stores intrusion information data on a memory storage means.

18. A method for detecting intrusions as claimed in claim 15, wherein said threshold value is a static value.

19. A method for detecting intrusions as claimed in claim 15, wherein said threshold value is a dynamic value which changes over time.
